(19) United States
(12) Patent Application Publication
(10) Pub. No.: US 2013/0080639 A1
(43) Pub. Date: Mar. 28, 2013

(54) QUALITY OF SERVICE IN A STRUCTURED PEER-TO-PEER NETWORK

(71) Applicant: Chin-Hsin Jeffrey CHANG, Sunnyvale, CA (US)

(72) Inventor: Chin-Hsin Jeffrey CHANG, Sunnyvale, CA (US)

(73) Assignee: AWIT Systems, Inc., Sunnyvale, CA (US)

(21) Appl. No.: 13/609,659

(22) Filed: Sep. 11, 2012

Related U.S. Application Data
(60) Provisional application No. 61/538,798, filed on Sep. 24, 2011.

(51) Int. Cl. G06F 15/173

(52) U.S. Cl. 709/226

(57) ABSTRACT

This present invention is to classify the nodes into different roles for the purpose of routing packet and storing data. This is needed because each node in the Distributed Hash Table (DHT) network may have various capacities in terms of network bandwidth and disk storage. That is to say, this invention is focusing on assigning distinct functional roles (Server/Peer/Client) to nodes in the network based on the prior art (algorithm Kademlia). By using XOR of node ID's numeric values the distance between all the nodes can be known.

### BACKGROUND OF THE INVENTION

1. Field of the Invention

The present invention relates generally to a network that implements Distributed Hash Table (DHT) and, more particularly, but not exclusively to classify the nodes into different roles for the purpose of routing packet and storing data.

2. Description of Related Art

Identity:

The node ID in DHT network is usually randomly generated, for example, using the SHA1 hash value of the node's RSA public key, which make the ID evenly distributed in the DHT namespace.

The data ID is generated based on the hash value of the key part of its key-value pair. The same SHA1 hash function for node ID generation is used, so it has the same bit-length as the node ID, and both ID's are put into a single DHT namespace.

Routing:

When a node N receive a packet P with destination node ID of T, and N find that, of all the neighbor nodes that N is keeping track of, the closest node to T is S, then N just forwards P to S, which will perform the same logic and eventually the packet is routed to its destination of node T.

Storage:

In the DHT network, the node ID and data ID shares the same namespace (for example, a 128-bit number). For a key-value pair data of ID D, it's stored at the node of ID R, where R is the numerically closest neighbor to D. Node R is then called the Rood node for data D, i.e. R:=Root(D).

Distance by XOR Values

The way each node in DHT keeps track of neighboring nodes is given that XOR of node ID's numeric values is used as the distance between nodes. An example (and popular) algorithm is Kademlia:

Please refer to FIG. 1 which is an example of a distance tree with XOR property. As shown in the figure, number N here may be number 6 for simplicity. Thus, the node A may have a node ID 000000 which denotes from bit 0 to bit 6 (from bit 0, left hand side branch may be 0 and right hand side may be 1), and the node B aside node A may have a node ID 000001 which also denotes from bit 0 to bit 6. After XOR procedure, the distance between node A and node B is 000001. Also, the node C may have a node ID 000011 which denotes from bit 0 to bit 6. After XOR procedure, the distance between node A and node C is 000011, and the distance between node B and node C is 000010. Therefore, by using XOR of node ID's numeric values the distance between nodes can be known.

### SUMMARY OF THE INVENTION

A method of classifying nodes for routing packet and storing data is disclosed, comprising: defining a plurality of nodes into a plurality of kinds of node groups in a network: a server node group, a peer node group and a client node group, wherein the nodes in the server node group are used for packet routing and data storage, and the nodes in the peer node group are used for packet routing; and dividing a plurality of data IDs into a plurality of types: a first type and a second type, wherein the data IDs in the first type are closer to the server node group than the peer node group, and farthest to the client node group, and the data IDs in the second type are closer to the peer node group than the server node group, and farthest to the client node group.

A system for routing packet and storing data is further provided. The system comprises a plurality of node groups, comprising: a server node group, a peer node group and a client node group, wherein the nodes in the server node group are used for packet routing and data storage, and the nodes in the peer node group are used for packet routing; and two types, comprising: a first type and a second type, wherein the data IDs in the first type are closer to the server node group than the peer node group, and farthest to the client node group, and the data IDs in the second type are closer to the peer node group than the server node group, and farthest to the client node group.

A network with a peer-to-peer protocol for routing packet and storing data is further provided. The network with a peer-to-peer protocol comprises a transceiver to send and receive data over the network; and a processor that is configured to: define a plurality of nodes into a plurality of kinds of node groups in a network: a server node group, a peer node group and a client node group, wherein the nodes in the server node group are used for packet routing and data storage, and the nodes in the peer node group are used for packet routing, and wherein the client node group is closer to the server node group than the peer node group; and divide a plurality of data IDs into a plurality of types: a first type and a second type, wherein the data IDs in the first type are closer to the server node group than the peer node group, and farthest to the client node group, and the data IDs in the second type are closer to the peer node group than the server node group, and farthest to the client node group.

With these and other objects, advantages, and features of the invention that may become hereinafter apparent, the nature of the invention may be more clearly understood by reference to the detailed description of the invention, the embodiments and to the several drawings herein.

### BRIEF DESCRIPTION OF THE DRAWINGS

The exemplary embodiment(s) of the present invention will be understood more fully from the detailed description given below and from the accompanying drawings of various embodiments of the invention, which, however, should not be taken to limit the invention to the specific embodiments, but are for explanation and understanding only.

FIG. 1 is an example for XOR distance tree.

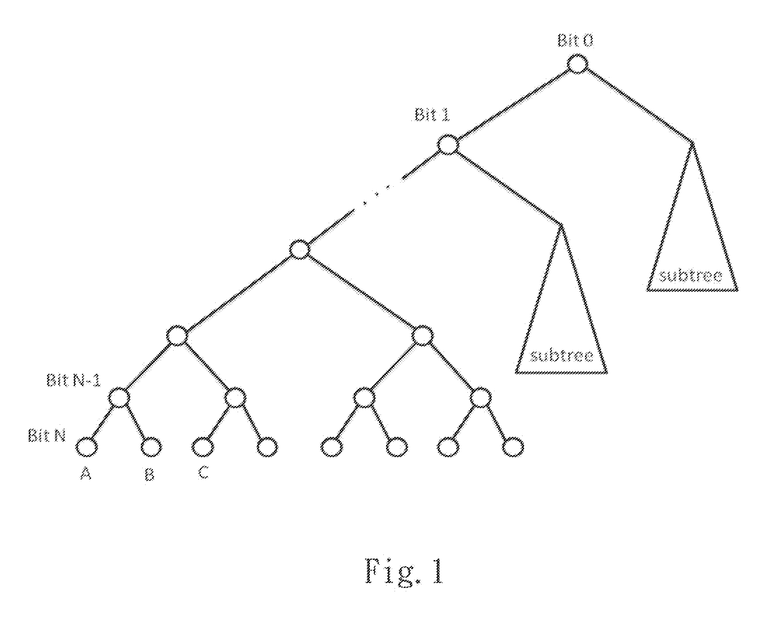

FIG. 2 is a system diagram of one embodiment of an environment in which the invention may be practiced.

FIG. 3 is a schematic view illustrating an embodiment of a distance graph of various roles according to the present invention.

FIG. 4 is a schematic view illustrating another embodiment of a distance graph of various roles according to the present invention.

FIG. 5 illustrates operation of certain aspects of the invention.

### DETAILED DESCRIPTION OF THE PREFERRED EMBODIMENTS

The present invention now will be described more fully hereinafter with reference to the accompanying drawings, which form a part hereof, and which show, by way of illustration, specific exemplary embodiments by which the invention may be practiced. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods or devices. Accordingly, the present invention may take the form of an entirely hardware embodiment, an entirely software embodiment or an embodiment combining software and hardware aspects. The following detailed description is, therefore, not to be taken in a limiting sense.

Throughout the specification and claims, the following terms take the meanings explicitly associated herein, unless the context clearly dictates otherwise. The phrase “in one embodiment” as used herein does not necessarily refer to the same embodiment, though it may. Furthermore, the phrase “in another embodiment” as used herein does not necessarily refer to a different embodiment, although it may. Thus, as described below, various embodiments of the invention may be readily combined, without departing from the scope or spirit of the invention.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

Illustrative Operating Environment

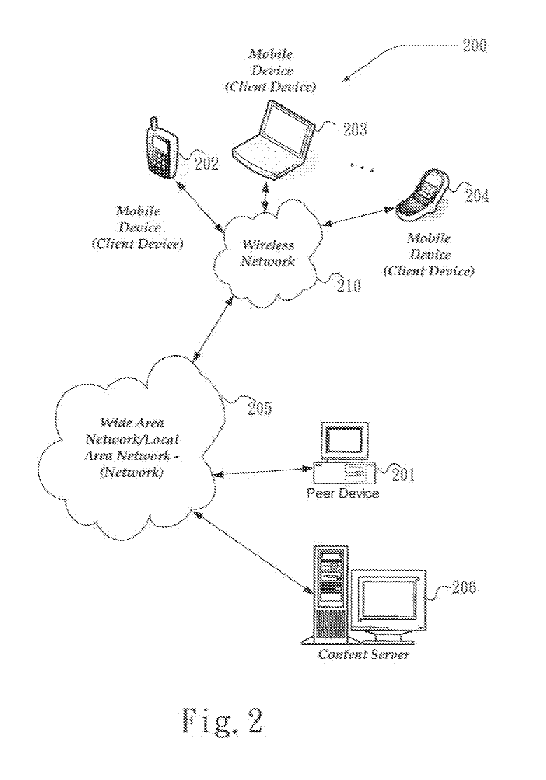

FIG. 2 shows components of one embodiment of an environment in which the invention may be practiced. Not all the components may be required to practice the invention, and variations in the arrangement and type of the components may be made without departing from the spirit or scope of the invention. As shown, system 200 of FIG. 2 includes networks that enable communication between client and network devices or servers. A network 205 may comprise one or more local area networks (“LANs”) and/or wide area networks (“WANs”). A wireless network 210 may comprise LANs, WANs, telephony networks, or the like. System 200 also includes a general purpose peer device 201, mobile client devices 202-204, and content server 206.

Generally, mobile devices 202-204 may include virtually any portable computing device capable of receiving and sending a message over a network, such as network 205, wireless network 210, or the like. Mobile devices 202-204 may also be described generally as client devices that are configured to be portable. Thus, mobile devices 202-204 may include virtually any portable computing device capable of connecting to another computing device and receiving information. Such devices include portable devices such as, cellular telephones, smart phones, display pagers, radio frequency (RF) devices, infrared (IR) devices, Personal Digital Assistants (PDAs), handheld computers, laptop computers, wearable computers, tablet computers, integrated devices combining one or more of the preceding devices, and the like. As such, mobile devices 202-204 typically range widely in terms of capabilities and features. For example, a cell phone may have a numeric keypad and a few lines of monochrome LCD display on which only text may be displayed. Such mobile devices may include a messaging client that enables a user to send and receive limited size text messages, but may not enable a user to send or receive long messages, graphics, images, or other content.

In another example, a web-enabled mobile device may have a touch sensitive screen, a stylus, and several lines of color LCD display in which both text and graphics may be displayed. A web-enabled mobile device may include a messaging client and a browser application that is configured to receive and to send web pages, web-based messages, and the like. The browser application may be configured to receive and display graphics, text, multimedia, and the like, employing virtually any web based language, including a wireless application protocol messages (WAP), and the like. In one embodiment, the browser application is enabled to employ Handheld Device Markup Language (HDML), Wireless Markup Language (WML), WMLScript, JavaScript, Standard Generalized Markup Language (SMGL), HyperText Markup Language (HTML), extensible Markup Language (XML), and the like, to display and send a message. In one embodiment, a user of the mobile device may employ the browser application to exchange text messages that include search queries and search results. A user may also employ a browser application to access additional search result content that is identified in one or more text messages.

Peer device 201 may include virtually any computing device capable of communicating over a network to send and receive information, including search query information, location information, social networking information, or the like. The set of such devices may include devices that typically connect using a wired or wireless communications medium such as personal computers, multiprocessor systems, microprocessor-based or programmable consumer electronics, network PCs, or the like. Peer device 201 may include a messaging system and/or interface for sending or receiving text messages with mobile devices 202-204 or other client devices.

Wireless network 210 is configured to couple mobile devices 202-204 and its components with network 205. Wireless network 210 may include any of a variety of wireless sub-networks that may further overlay stand-alone ad-hoc networks, and the like, to provide an infrastructure-oriented connection for mobile devices 202-204. Such sub-networks may include cellular networks, mesh networks, Wireless LAN (WLAN) networks, and the like.

Network 205 is enabled to employ any form of computer readable media for communicating information from one electronic device to another. Also, network 205 can include the Internet in addition to local area networks (LANs), wide area networks (WANs), direct connections, such as through a universal serial bus (USB) port, other forms of computer-readable media, or any combination thereof. On an interconnected set of LANs, including those based on differing architectures and protocols, a router acts as a link between LANs, enabling messages to be sent from one to another. Also, communication links within LANs typically include twisted wire pair or coaxial cable, while communication links between networks may utilize analog telephone lines, full or fractional dedicated digital lines including T1, T2, T3, and T4, Integrated Services Digital Networks (ISDNs), Digital Subscriber Lines (DSLs), wireless links including satellite links, or other communications links known to those skilled in the art. Furthermore, remote computers and other related electronic devices could be remotely connected to either LANs or WANs via a modem and temporary telephone link. In essence, network 205 includes any communication method by which information may travel between content server 206, peer device 201, and other computing devices.

Content server 206 represents a variety of content and/or other data that may useable on mobile devices 202-204 and/or on peer device 201. Such content may include text content, web content, audio content, video content, FTP data, or the like. Data services may include, but are not limited to SMS, IM services, email services, services, web services, third-party services, audio services, video services, VOIP services, calendaring services, photo services, or the like. Devices that may operate as content server 206 include personal computers desktop computers, multiprocessor systems, microprocessor-based or programmable consumer electronics, network PCs, servers, and the like.

Generalized Implementation

As noted herein, exemplary embodiments are directed to quality of service in a structured peer-to-peer network. In a network that implements Distributed Hash Table (DHT), a node in the network can be used to store both routing information and key-value pair data, based on both node ID and data ID. Each node keeps track of a set of neighboring nodes, such that any node in the network can find all other nodes in the network through relays without keeping information of every node in the network.

Not all nodes in the DHT network are created equal in the present invention. For example, mobile devices, with limited bandwidth & battery, might prefer not want to route traffic in the network, whereas untrusted/unreliable nodes should not store important data. In order to keep all nodes and data within one single namespace while being able to prioritize the routing and storage preferences, each node in the DHT network is assigned different roles based on its node ID, without any change to the DHT algorithm that make the routing & storage logic sound.

In one embodiment, for given nodes are defined 3 roles in the DHT network: (1) Server node, which prefers to do both packet routing and data storage functionalities. (2) Peer node, which prefers to do only packet routing, but not data storage, functionalities. (3) Client node, which prefers neither packet routing nor data storage.

Also, to implement the above 3 different node roles, here's the requirements:

(1) For data storage, it's desired that the data ID is always closer to some specific set of node ID than the rest of nodes, so that data identified by data ID can be stored at the “Root” node whose node ID is the one with the closest numeric distance to data ID than the rest of nodes. Furthermore, data IDs can be divided into two types: (i) S-Data ID: those who are closer to Server nodes than Peer nodes, and farthest to Client nodes. (ii) P-Data ID: those who are closer to Peer nodes than Server nodes, and farthest to Client nodes.

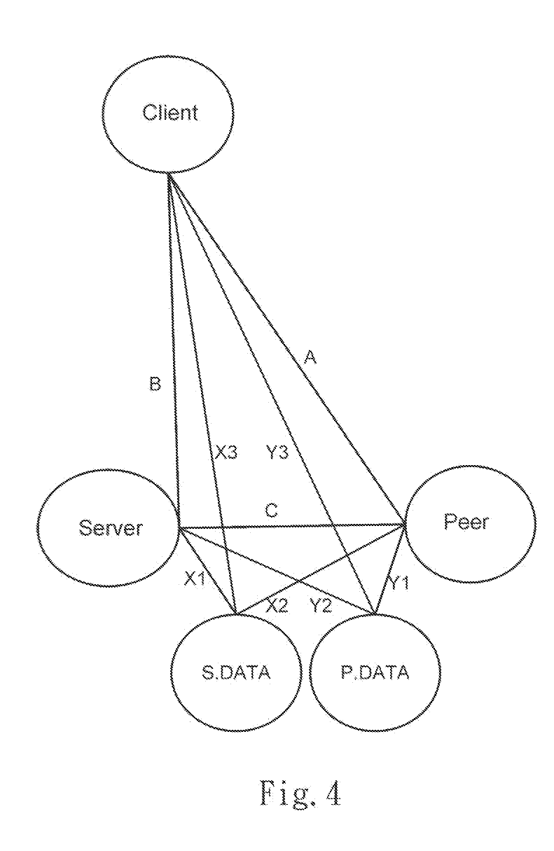

Here's the above requirements in mathematical forms: (d(x,y) represents the distance/closeness between ID x and ID y, and the value of distance is represented in Hexadecimal). Also, please refer to FIG. 4 which is a schematic view illustrating an embodiment of a distance graph of various roles according to the present invention.

Distance Requirement for Storage Preference:

d(S.DATA, Server)<d(S.DATA, Peer)<d(S.DATA, Client) (I)

d(P.DATA, Peer)<d(P.DATA, Server)<d(P.DATA, Client) (II)

(2) For packet routing, it's desired that a set of node IDs (Client) are always closer to some specific set of node ID (Server) than the rest of nodes (Peer). This means Client nodes only need to keep connection with its closest Server nodes, which will receive packets from the rest of the system that's destined for Client nodes. This would spare Client node from packet routing responsibilities.

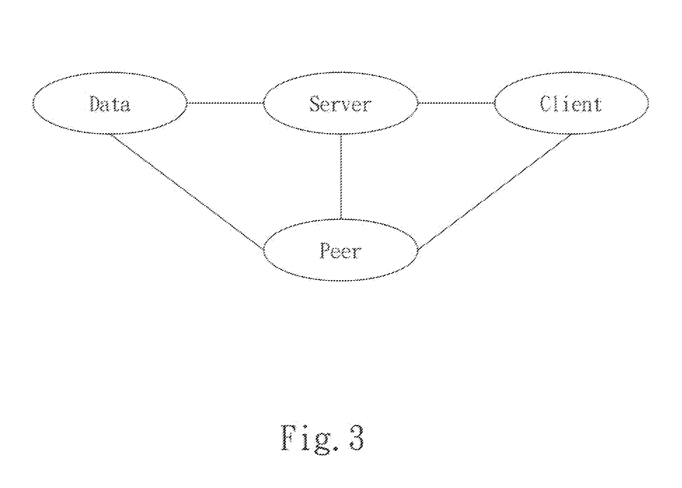

Here's the above requirements in mathematical forms: (d(x,y) represents the distance/closeness between ID x and ID y). Also, please refer to FIG. 3 which is a schematic view illustrating an embodiment of a distance graph of various roles according to the present invention.

Distance Requirement for Routing Preference:

d(Peer, Server)<d(Client, Server)<d(Client, Peer)

Further, given a node ID or data ID with numeric value, and given that the “closeness” of ID is calculated via mathematic XOR operator. Prefix can be added to the ID to satisfy the 2 requirements above. Here's an embodiment of pretending some calculated bit values in front of the IDs for implementing the design:

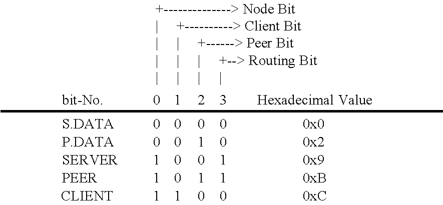

As shown in the embodiment, Server, Peer, Client, S.DATA and P.DATA may be divided into 2 groups by Data Bit. Server, Peer and Client may be in one group (with Data Bit as 0), and S.DATA and P.DATA may be in the other group (with Data Bit as 1). In addition, by using Client Bit and Peer Bit, Server, Peer and Client can be keeping in their positions (virtual), respectively in one group. Similarly, through Peer Bit, S.DATA and P.DATA can be kept in their positions (virtual), respectively in the other group. Therefore, by using XOR of node ID's numeric values the distance between all the nodes can be known. The smaller result after XOR procedure between two nodes, the closer they are.

Please see the following XOR results according to the prefix embodiment above:

| | XOR | | |
|---|---|---|---|
| | Server | Peer | Client |
| Distance | (0x9) | (0xB) | (0xC) |
| S.DATA (0x0) | 0x9 | 0xB | 0xC |
| P.DATA (0x2) | 0xB | 0x9 | 0xE |

Distance Requirement for Storage Preference:

$$\begin{matrix}d {( S . DATA , Server )}_{0 \times 9} {<}_{<} d {( S . DATA , Peer )}_{0 \times B} {<}_{<} d {( S . DATA , Client )}_{0 \times C} & ( I ) \\ d {( P . DATA , Peer )}_{0 \times 9} {<}_{<} d {( P . DATA , Peer )}_{0 \times B} {<}_{<} d {( P . DATA , Client )}_{0 \times E} & ( II )\end{matrix}$$

Also, by Routing Bit, the routing distances of Server, Peer and Client can be calculated via mathematic XOR operator. Please see the results below.

| | | XOR | | |
|---|---|---|---|---|
| | | Server | Peer | Client |
| Distance | | (0x9) | (0xB) | (0xC) |
| Server | (0x9) | 0x0 | 0x2 | 0x5 |
| Peer | (0xB) | 0x2 | 0x0 | 0x7 |
| Client | (0xC) | 0x5 | 0x7 | 0x0 |

Distance Requirement for Routing Preference:

$$d {( Peer , Server )}_{0 \times 2} {<}_{<} d {( Client , Server )}_{0 \times 5} {<}_{<} d {( Client , Peer )}_{0 \times 7}$$

Please refer to FIG. 4 which is a schematic view illustrating another embodiment of a distance graph of various roles according to the present invention. As shown in the figure, A, B, C, X1, X2, X3, Y1, Y2, and Y3 denotes the distances between the nodes, respectively. Based on previous discussion, the distance between Server, Peer, Client, S.DATA and P.DATA will be shown as the following:

X1<X2<X3, Y1<Y2<Y3, and C<B<A.

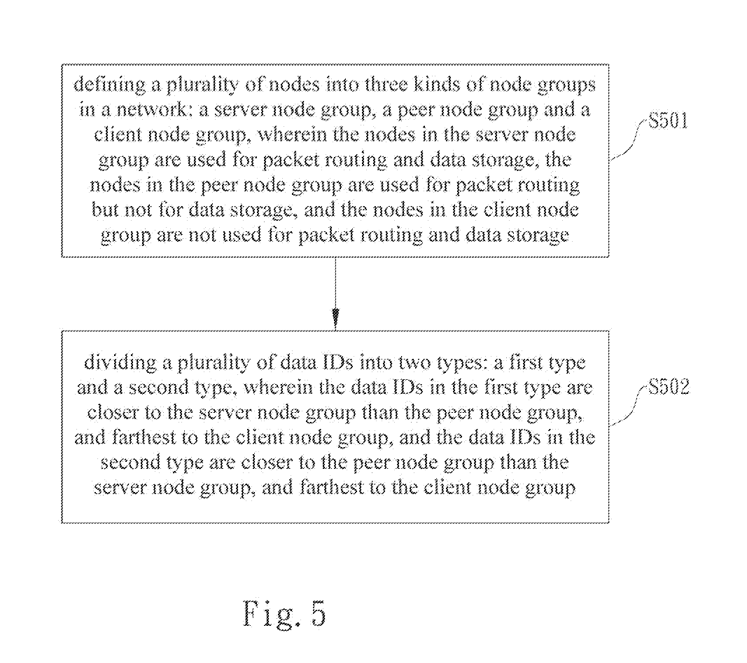

FIG. 5 illustrates operation of certain aspects of the invention. The method of classifying nodes for routing packet and storing data comprises the following steps:

(S501) defining a plurality of nodes into three kinds of node groups in a network: a server node group, a peer node group and a client node group, wherein the nodes in the server node group are used for packet routing and data storage, the nodes in the peer node group are used for packet routing but not for data storage, and the nodes in the client node group are not used for packet routing and data storage; and

(S502) dividing a plurality of data IDs into two types: a first type and a second type, wherein the data IDs in the first type are closer to the server node group than the peer node group, and farthest to the client node group, and the data IDs in the second type are closer to the peer node group than the server node group, and farthest to the client node group.

The detailed description and embodiments of method according to this invention are given above, and so unnecessary details are not given here.

In summary, here are the advantages of the invention over both the pure peer-to-peer mode and traditional Client-Server architecture:

1. Simplicity: there's no need to change the existing proximity-based DHT algorithms for grouping the nodes, as well as data, into multiple classes and provision them with various functionalities based on class type. For this invention to be adopted by any XOR-based algorithm, the only implementation change is to add prefix digits in the node or data ID, in order to classify them into multiple categories, and provide different level of quality of service over them.

2. Zero-Configuration: this invention allows automatic provisioning of service, like routing and storage, without any configuration changes of the network. For a given node to provide routing or storage service, all it needs to do is to announce a new Node ID with custom prefixes in this invention, and the whole network would be able to find and use its service immediately.

3. Efficient usage of resource: for devices with limited capacity like cellular phones or dispensable sensors, they can be classified as Client group role in this invention, and be spared from the responsibility of routing or storage in a peer-to-peer network. This would greatly reduce their network bandwidth usage, and increase their battery life and power efficiency.

4. Faster network response: nodes in the network can be classified according to this invention, so that only those with high bandwidth and/or low latency are allowed to provide network relay service in a structured peer-to-peer network. This would improve the response time of the connection, and increase the throughput of the overall network.

5. Reliable Storage: by using algorithm in this invention, the designated group is preferred as the root storage for specific data. For example, S.DATA would be stored at Server if available, and P.DATA at Peer. An application of this is that, data that need reliable storage at Server can be classified as S.DATA, whereas transient data can be stored at Peer node that may not always be available.

While particular embodiments of the present invention have been shown and described, it will be obvious to those skilled in the art that, based upon the teachings herein, changes and modifications may be made without departing from this invention and its broader aspects. Therefore, the appended claims are intended to encompass within their scope of all such changes and modifications as are within the true spirit and scope of the exemplary embodiment(s) of the present invention.

What is claimed is:

1. A method of classifying nodes and data in the network into multiple groups, whereas each group defines different levels of quality of service for routing packet and storing data, comprising:
defining a plurality of nodes into a plurality of kinds of node groups in a network: a server node group, a peer node group and a client node group, wherein the nodes in the server node group are used for packet routing and data storage, and the nodes in the peer node group are used for packet routing; and
dividing a plurality of data IDs into a plurality of types: a first type and a second type, wherein the data IDs in the first type are closer to the server node group than the peer node group, and farthest to the client node group, and the data IDs in the second type are closer to the peer node group than the server node group, and farthest to the client node group.

2. The method of claim 1, wherein the nodes in the peer node group are not used for data storage, and the nodes in the client node group are not used for packet routing and data storage.

3. The method of claim 1, wherein the client node group is closer to the server node group than the peer node group.

4. The method of claim 1, wherein the data IDs are used for data storage.

5. The method of claim 1, wherein the method is implemented by a binary numeral system.

6. The method of claim 1, wherein the node groups differ from the data IDs by at least one bit.

7. The method of claim 1, wherein the server node group and the peer node group differ from the client node group by at least one bit.

8. A system for routing packet and storing data, comprising:
a plurality of node groups, comprising:
a server node group, a peer node group and a client node group, wherein the nodes in the server node group are used for packet routing and data storage, and the nodes in the peer node group are used for packet routing; and
two types, comprising:
a first type and a second type, wherein the data IDs in the first type are closer to the server node group than the peer node group, and farthest to the client node group, and the data IDs in the second type are closer to the peer node group than the server node group, and farthest to the client node group.

9. The system of claim 8, wherein the nodes in the peer node group are not used for data storage, and the nodes in the client node group are not used for packet routing and data storage.

10. The system of claim 8, wherein the client node group is closer to the server node group than the peer node group.

11. The system of claim 8, wherein the data IDs are used for data storage.

12. The system of claim 8, further comprising a binary numeral system.

13. The system of claim 8, wherein the node groups differ from the data IDs by at least one bit.

14. The system of claim 8, wherein the server node group and the peer node group differ from the client node group by at least one bit.

15. A network with a peer-to-peer protocol for routing packet and storing data, comprising:
a transceiver to send and receive data over the network; and
a processor that is configured to:
define a plurality of nodes into a plurality of kinds of node groups in a network: a server node group, a peer node group and a client node group, wherein the nodes in the server node group are used for packet routing and data storage, and the nodes in the peer node group are used for packet routing, and wherein the client node group is closer to the server node group than the peer node group; and
divide a plurality of data IDs into a plurality of types: a first type and a second type, wherein the data IDs in the first type are closer to the server node group than the peer node group, and farthest to the client node group, and the data IDs in the second type are closer to the peer node group than the server node group, and farthest to the client node group.

16. The network of claim 15, wherein the nodes in the peer node group are not used for data storage, and the nodes in the client node group are not used for packet routing and data storage.

17. The network of claim 15, wherein the data IDs are used for data storage.

18. The network of claim 15, further comprising a binary numeral system.

19. The network of claim 15, wherein the node groups differ from the data IDs by at least one bit.

20. The network of claim 15, wherein the server node group and the peer node group differ from the client node group by at least one bit.
